(19) United States
(12) Patent Application Publication
(10) Pub. No.: US 2006/0100953 A1
(43) Pub. Date: May 11, 2006

(54) Data processing flow chart control system

(76) Inventor: Haskell E. Downs II, Austin, TX (US)

Correspondence Address: Haskell E. Downs II, Suite 425, 7000 N. MoPac, Austin, TX, 78731, US

(21) Appl. No.: 10/985,181

(22) Filed: Nov. 10, 2004

(51) Int. Cl. G06Q 40/00

(52) U.S. Cl. 705/37

(57) ABSTRACT

A data processing flow chart control system includes a variable sequence series of independent data processing blocks for receiving input data corresponding to price versus time data for a variable price item and for generating time-related entry and exit signals corresponding to the acquisition and disposition of rights to the variable price item. A data processing sequence control system may be selectively configurable between a closed data processing configuration and an open programming configuration. The data processing sequence control system selectively allows each data processing block to be reconfigured between a data processing configuration and a block reprogramming configuration. Successive trading strategy variations made during the development of an optimized trading strategy are intended to incrementally improve the trading decision information, leading up to an order block at the end of the process, where the final filtered, confirmed, and otherwise modified trading decision is executed, either in simulated or real trading.

### BACKGROUND OF THE INVENTION

1. Field of the Invention

This invention relates to providing the ability to program data processing software by creating flow chart boxes and by arranging the flow chart boxes into a desired sequence, and more particularly, to a data processing flow chart control system including a series of independent data processing blocks for receiving input data corresponding to price versus time data for a variable price item and for generating time-related entry and exit signals corresponding to the acquisition and disposition of rights to the variable price item.

2. Description of the Prior Art

Highly automated, complex trading software has been available for many years. Development of such trading programs has required high level programming skills not commonly possessed by traders. To the extent that such trading software was user adjustable or configurable, reconfiguring the software and back testing to evaluate the modified results represented a time consuming, tedious operation not easily mastered by most traders.

A need has existed to enable traders to create their own trading strategies, to readily modify a logical sequence of data processing steps as well as the parameters applied to each processing step to enable a trader to create without undue effort or a high level of skill in customizing trading strategies.

An additional need has been to be able to create trading strategies that generate superior trading ideas which generate more profitable trades. The invention addresses this need by uniquely providing a way to successively build upon the success of an initial algorithm or trading idea, adding a potentially unlimited number of refinements to the basic trading idea so as to incrementally improve performance, or profitability, of the final trading signal.

The present invention meets such needs by providing a programmable data processing sequence control system including a series of independent data processing blocks for receiving input data corresponding to price versus time data for a variable price item and for generating time-related entry and exit signals corresponding to the acquisition and disposition of rights to the variable item price. The system provides a data processing sequence control panel which is selectively configurable between a closed data processing configuration and an open programming configuration for selectively allowing each data processing block to be reconfigured between the minimized data processing configuration and a maximized block reprogramming configuration.

### DESCRIPTION OF THE DRAWINGS

The invention is pointed out with particularity in the appended claims. However, other objects and advantages together with the operation of the invention may be better understood by reference to the following detailed description taken in connection with the following illustrations, wherein:

FIG. 1 illustrates a time versus price graph of an actively traded stock.

FIG. 2 represents a block diagram illustration of one embodiment of the present invention.

FIG. 3 illustrates a more detailed block level diagram of one embodiment of the present invention.

FIGS. 4-8 illustrate various data processing flow chart control system configurations.

FIGS. 9-12 illustrate the maximized configuration of a Multiple Systems Data Processing block of the present invention (i.e., an “exploded” view of each Processing block, containing the specific parameters used therein).

FIGS. 13 and 14 illustrate the maximized reprogrammable configuration of the Performance block.

FIG. 15 illustrates a data processing flow chart control system having a Vote block.

FIGS. 16 and 17 illustrate different Vote block programming parameters.

FIGS. 18 and 19 illustrate various flow chart placement positions for the Vote block.

FIGS. 20-23 relate to the configuration, placement and programming of the Confirmation block.

FIGS. 24-26 relate to parameter programming capabilities for the Orders block.

FIG. 27 represents a block diagram illustrating parallel channel data processing.

FIGS. 28-33 illustrate various configurations of a data processing sequence control system of the present invention.

FIG. 34 illustrates a complex parallel data processing embodiment.

FIGS. 35-42 illustrate the Filter block in both the minimized data processing configuration and in the maximized reprogramming configuration.

FIGS. 43-45 illustrate the Actions, Strategies, and Test Setting tabs for the To Do List.

FIG. 46 illustrates a new Strategies box.

FIG. 47 illustrates an unprogrammed visual flow chart control panel.

FIGS. 48 and 49 illustrate the Performance and Signal Generation tabs of the All Strategies Voting box.

FIG. 50 illustrates a representative data processing sequence control system configuration.

### DESCRIPTION OF THE PREFERRED EMBODIMENT

In order to better illustrate the advantages of the invention and its contributions to the art, a preferred embodiment of the invention will now be described in some detail.

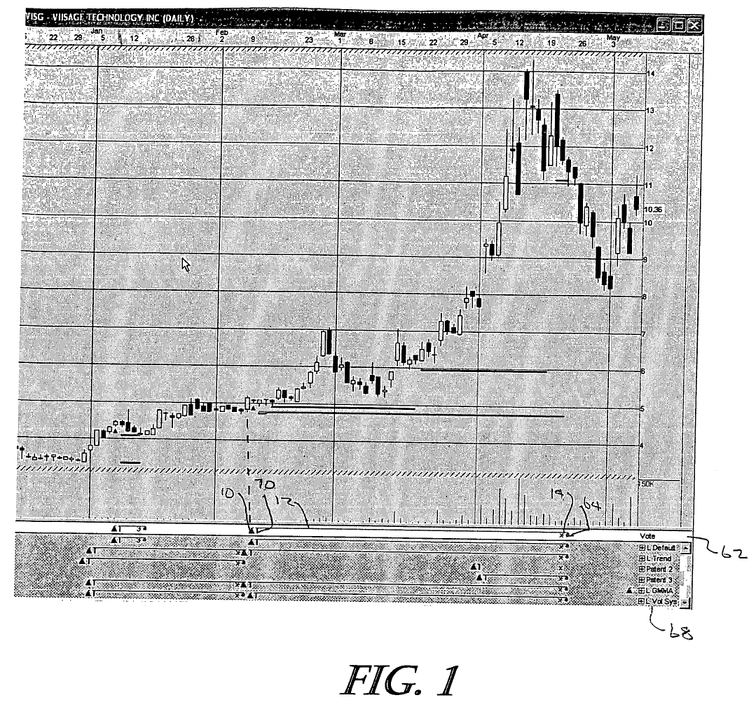

The upper portion of FIG. 1 illustrates a typical daily price versus time candlestick chart for Visage Technology, Inc. referred to by the security symbol VISG. As reflected by the chart X-axis data scale which appears along the upper horizontal border of FIG. 1, the chart displays daily candlestick price bars for VISG from late December 2003 through early May 2004. White candlestick symbols indicate that the closing price exceeds the opening price while black candlesticks reflect a daily closing price less than the opening price.

The thin vertically oriented bars extending along the lower X-axis boundary of the FIG. 1 daily price chart reflect the magnitude of the daily volume of shares traded for VISG.

“Vote” line 62 which extends horizontally along the FIG. 1 daily price chart immediately below the volume bars reflects the initial stock purchases or “entries,” the stock holding period and the sale of shares held or “exits” at the right hand termination of each horizontal line segment. For example, in FIG. 1, the black colored triangular symbol designated by reference number 10 symbolizes a software generated “entry” signal where the trader should buy VISG. The individual unvoted entry signals represented the plurality of horizontally extending lines depicted immediately below the vote line will be explained below.

The presence of the laterally extending horizontal line 12 to the right of entry signal 10 indicates that VISG should be held and not sold until an exit signal has been generated. Reference number 14 indicating the right hand termination of the vote line segment illustrated in FIG. 1 designates that an exit signal has now been generated. Based on user preferences programmed into the software as explained below, the user should sell his long position in VISG either at the end of the same trading day or at the market opening on the following day.

The daily price versus time data illustrated in FIG. 1 represents readily available input data which corresponds to price versus time data for a variable price item such as the VISG security and further illustrates how the inventive software generates time-related entry and exit signals corresponding to the acquisition or disposition of rights to a variable price item such as shares of stock, options, futures, commodities or any other variable price item.

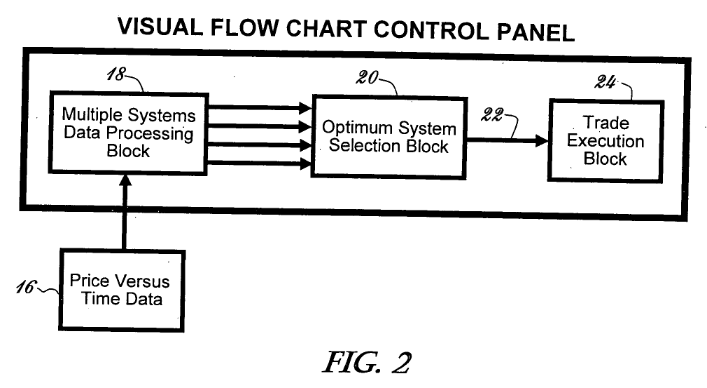

The FIG. 2 block diagram illustrates one embodiment of a visual flow chart control system embodiment of the present invention. Block 16 represents a conventional source of price versus time data which could be provided in daily, hourly, minutes, seconds or tick by tick data. FIG. 2 illustrates the visual flow chart control panel configured in a closed data processing configuration. FIG. 2 facilitates a general level explanation of the operating methodology of the present invention. Reference number 18 designates a Multiple Systems Data Processing block positioned within the visual flow chart control panel. Multiple Systems Data Processing block 18 incorporates two or more selectively activated data processing algorithms for independently processing the price versus time data over a preset back test period. Multiple Systems Data Processing block 18 also periodically generates discrete trade execution output signals for each algorithm. Multiple Data Systems Processing Block 18 includes a minimized processing configuration as illustrated in FIG. 2 as well as a maximized reprogramming configuration which will be described below in which internal system processing parameters are displayed and rendered reprogrammable.

Reference number 20 in FIG. 2 designates the optimum System Selection block which is positioned within the visual flow chart control panel for ranking the quality of the signals generated by each data processing algorithm over the back test period by Multiple Systems Data Processing block 18. System Selection Block 20 may also be configured to reject or filter out the lower quality signals and passes only the highest quality trade execution signal to an output line 22. System Selection Block 20 includes a minimized processing configuration as illustrated in FIG. 2 as well as a maximized programming configuration which will be described below in which internal processing parameters are displayed and rendered reprogrammable.

Output 22 from System Selection block 20 is passed to Trade Execution block 24 which generates valid trade execution signals in the form illustrated in FIG. 1 in response to the signals passed from the System Selection block output line 22. Trade execution block 24 includes a minimized processing configuration illustrated in FIG. 2 as well as a maximized programming configuration which will be described below in which internal processing parameters are displayed and rendered reprogrammable.

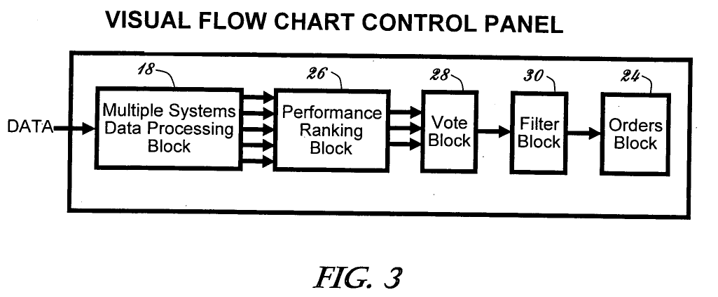

In the visual flow chart control panel illustrated in FIG. 3, a more specific version of the invention is illustrated in which System Selection block 20 has been further subdivided into a performance ranking block 26, Vote block 28 and Filter block 30. Performance ranking block 26 receives each of the processed outputs generated by Multiple Systems Data Processing block 18 and ranks the relative performance of each data processing algorithm over the back test period. It may also be programmed to reject or filter out lower quality signals.

The term “back test” period is a well known term of art in the field of trading and specifies the time span of previously recorded trading data which is collected and analyzed. Systems are typically evaluated and potentially optimized based on data derived from the historical back test period. The duration of the back test period for the inventive system may be readily adjusted from a short duration back test period to a longer duration back test period to a much longer duration back test period. One frequently utilized back test period for daily charts of the type illustrated in FIG. 1 might be specified as two hundred and fifty periods which corresponds to a typical one year period of trading days during which the New York Stock Exchange or the NASDAQ is open for business. Based on any individual user's needs or preferences, the back test period can be substantially shorter or potentially even longer.

The FIG. 3 flow chart illustrates that the multiple ranked outputs from performance ranking block 26 are then passed to the input of voting block 28 for the purpose of selecting according to predefined criteria, the most optimum output signal generated by performance ranking block 26.

The FIG. 3 flow chart further illustrates that the single output from Vote block 28 is passed to an input of Filter block 30 for the purpose of filtering out signals not meeting predefined, but adjustable filter criteria.

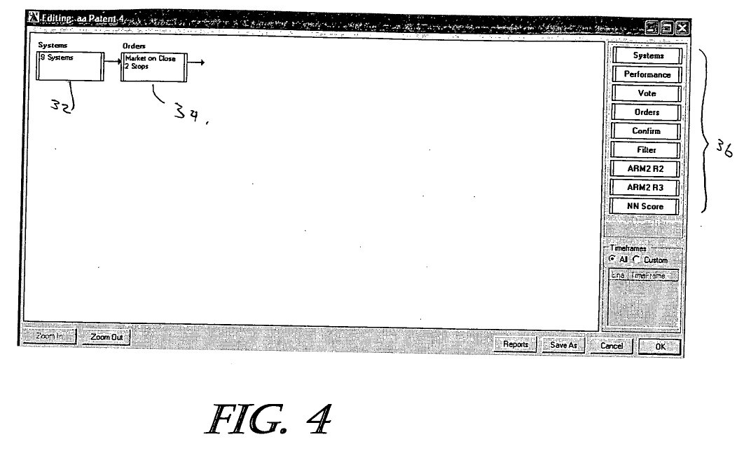

FIG. 4 represents an actual screen shot of a highly simplified embodiment of a data processing flow chart including a single Systems block 32 and a single Orders block 34. Systems block 32 corresponds to Multiple Systems Data Processing block 18 illustrated in FIG. 2 while Orders block 34 corresponds to Trade Execution block 24 illustrated in FIG. 2.

The right side of the visual flow chart control panel shown in FIG. 4 illustrates a flow chart selection panel 36 which includes a series of nine vertically stacked discrete function data processing blocks. The first discrete function data processing block is designated “Systems” while the last selectively discrete function data processing block is designated as “nn score,” representing a conventional neural network scoring data processing block. The selectable discrete function data processing blocks designated as “ARM2R2” and “ARM3R3” represent additional selectable discrete function data processing blocks of the type that could readily be incorporated into the visual flow chart control panel of the present invention in accordance with the needs and preferences of any particular group of traders. In fact, one of the advantages and key aspects of the flow chart orientation of the invention is that ANY block type can be added which adds further benefit or value to the signal-generation process.

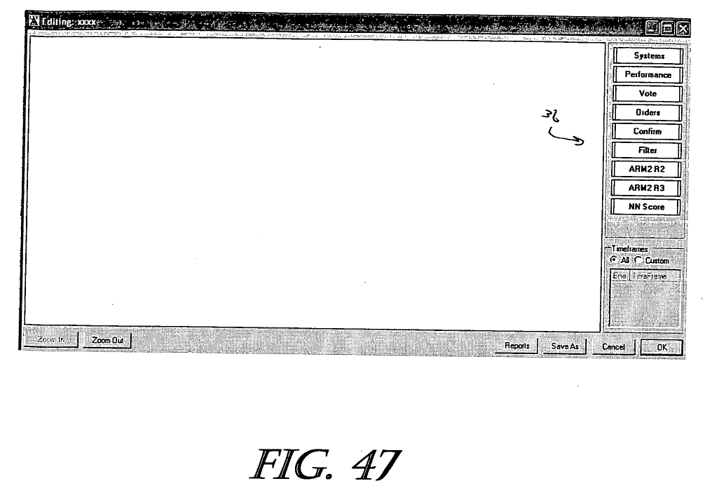

The two element visual flow chart illustrated in FIG. 4 is generated by having a user place a standard computer cursor over the discrete function data processing block entitled “Systems” within flow chart selection panel 36, left clicking on the mouse button and then dragging that Systems block into the initially blank rectangular white area of the visual flow chart control panel see FIG. 47). The dragged Systems block is released b releasing the mouse button and is then located in the position designated by reference number 32 as illustrated in FIG. 4.

To complete the FIG. 4 two element visual flow chart, the user once again right clicks on the “Orders” block located within flow chart selection panel 36 and drags the selected “Orders” block into the location designated by reference number 34 in FIG. 4. During this visual flow chart creation process, the software to automatically configures the horizontally oriented block interconnecting arrows as well as the related arrow representing the output from Orders block 34.

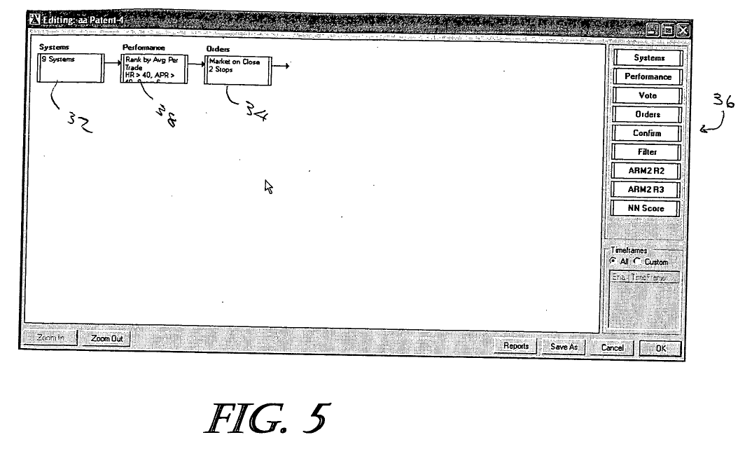

The FIG. 5 visual flow chart is related to the FIG. 4 visual flow chart except that a “Performance” block has been selected and dragged into position from the flow chart selection panel 36 and inserted in series between Systems block 32 and Orders block 34.

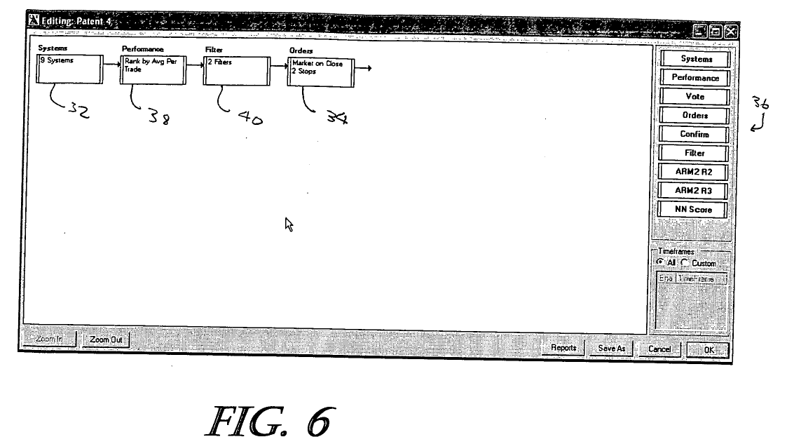

In the FIG. 6 visual flow chart, a Filter block 40 has been selected from the flow chart selection panel and dragged into position between Performance block 38 and Orders block 34.

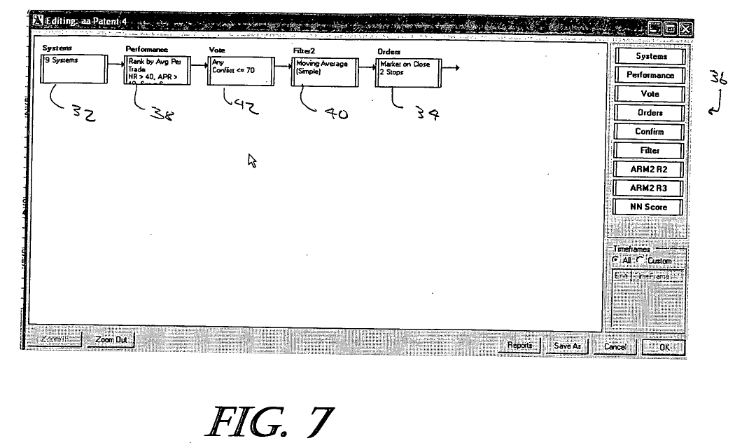

The FIG. 7 visual flow chart is based on the FIG. 6 visual flow chart except that a Vote block 42 has been selected from flow chart selection panel 36 and dragged into position between Performance block 48 and Filter block 40.

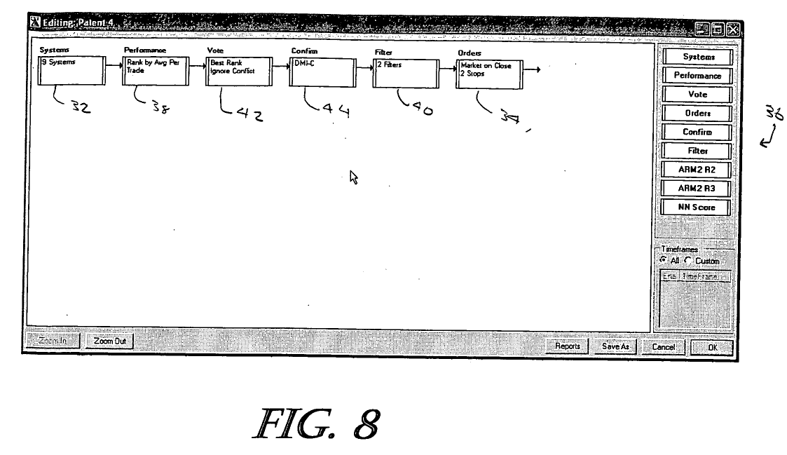

The FIG. 8 visual flow chart is based on the FIG. 7 visual flow chart except that a Confirm or Confirmation block 44 has been selected from flow chart selection panel 36 and dragged into position between Vote block 42 and Filter block 40.

The software is preferably programmed to allow a user to selectively reposition the relative sequential position of any of the discrete data processing blocks selected from flow selection panel as will be illustrated below. To prevent a user from sequencing a series of data processing blocks into inoperative relative sequential positions, the software may be configured such that the visual flow chart will not accept certain “disallowed” relative sequential positions for specific data processing blocks relative to other data processing blocks. For example, the data processing chain must always commence with a Multiple Systems Data Processing block 18 which must always be configured to receive price versus time data as illustrated in FIG. 2. Similarly, the sequential chain of selected data processing blocks which creates a particular trading strategy or trading system must always terminate with a Trade Execution block 24, alternatively referred to as an Orders block 24.

When a user selects a specific data processing block from flow chart selection panel 36 and attempts to place that selected data processing block into a “forbidden” or disallowed” sequential location, the data processing flow chart control system of the present invention rejects that proposed placement by refusing to accept the proposed sequential position for a particular data processing block. That refusal visually depicted by the system's refusal to generate the block to block interconnecting arrows. Alternatively, an appropriate text message could be displayed.

The data processing flow chart control system of the present invention is configured to indicate to the user “allowed” sequential positions for selected discrete function data processing elements by generating a bold black interconnecting flow chart connecting link or arrow whenever a user approaches within a defined proximity of a proposed “allowed” position with a data processing block selected from the flow selection panel. This method visually illustrates to the user who is essentially creating a unique programming methodology that the user's proposed data processing block sequencing is in fact “allowed” as opposed to “disallowed.”

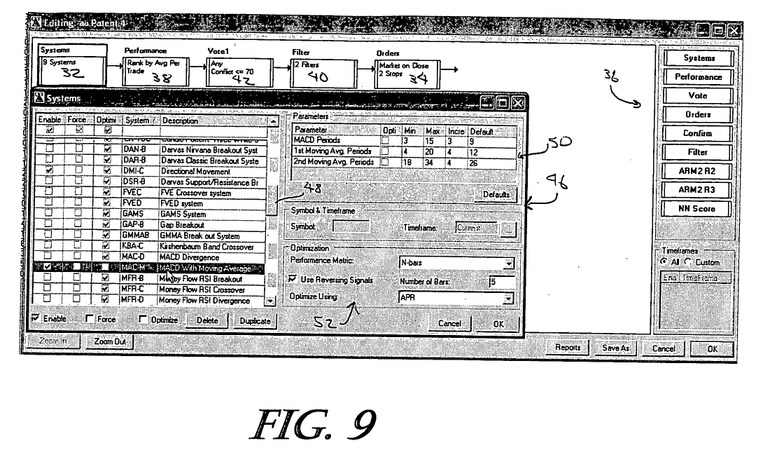

The FIG. 9 visual flow chart control panel illustrates that a user has double-clicked his mouse on Systems block 32 which instantaneously toggles Systems block 32 out of the minimized data processing configuration illustrated in FIGS. 2-8 and into the reprogramming configuration illustrated by the maximized Systems block 46 illustrated in FIG. 9. In this maximized or reprogramming configuration, the internal processing parameters of Systems block 46 are displayed and rendered reprogrammable.

In one embodiment, maximized Systems block 46 of FIG. 9 displays eighty-three separately selectable data processing algorithms. Such data processing algorithms are generally known in the trading field and have been available for many years. Nirvana Systems of Austin, Tex. has since the 1980's sold a series of OMNITRADER trading software products. The Nirvana Systems product designated as OMNITRADING 2003 represents the immediate past predecessor of the substantially improved OMNITRADER 2004 trading system. OMNITRADER 2004 incorporated the first visually programmable data processing flow chart control system of the present invention and adapted the eighty-three data processing algorithms from OMNITRADER 2003 as individual systems for internal use within Multiple Systems Data Processing block 18.

In the maximized reprogrammable configuration of Systems Data Processing block designated by reference number 46 in FIG. 9, the identity of each of these data processing algorithms may be displayed by appropriate displacements of vertical scroll bar 48. For example, in FIG. 9, a specific data processing algorithm designated “MACD With Moving Average” has been scrolled into view and highlighted which renders the MACD algorithm reprogrammable. The checkmark appearing in the “Enable” column confirms that this particular algorithm represents one of the “9 systems” designated within Systems block 32 as one of the nine operative or activated data processing algorithms out of the eighty-three available data processing algorithms.

When the cursor is clicked to highlight the MACD system as illustrated in FIG. 9, the algorithm processing parameters become available in Parameter block 50. To the extent a user wishes to have the computer software optimize any parameter of the selected MACD system, the column “Opti” of block 50 may be checked. Alternatively, the “Opti” block may be left unchecked and the user may click on any one of the parameters within Parameter Selection box 50 under the column headed “default” and type in any number of permitted parameters preferred by the user.

Within “Optimization” block 52, the user may also specify the methodology for having the computer software automatically optimize the selected processing algorithm internal parameters, using for example, in the depicted Optimization block 52, a performance metric based upon the prior five bars and further optimization using APR (annual percentage rate of return).

Whenever the user wishes to return to the vendor-supplied default algorithm parameters, the user merely clicks the “Defaults” box incorporated into the lower right hand corner of Parameter Selection box 50.

By left clicking on the “OK” box located in the lower right hand corner of maximized Systems block 46, the Systems block is automatically reconfigured or toggled from the maximized reprogramming configuration illustrated in FIG. 9 back into the minimized data processing configuration illustrated in FIG. 8.

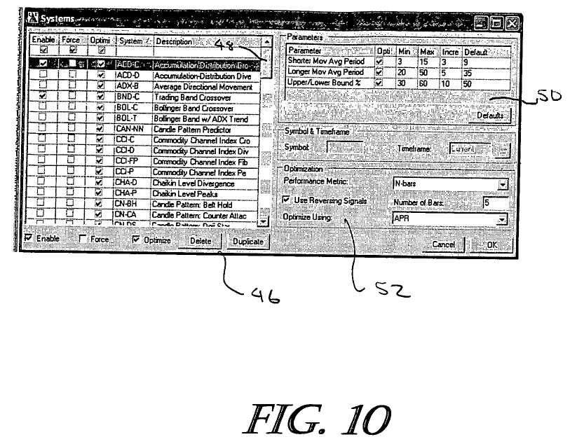

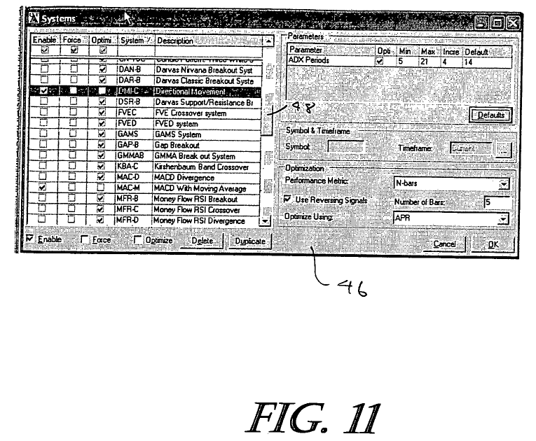

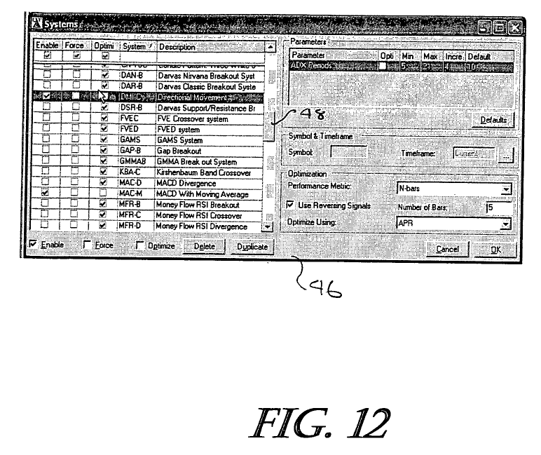

FIGS. 10, 11 and 12 further illustrate what is shown in FIG. 9 except that scroll bar 48 has been displaced either upward or downward showing that by placing checkmarks in the “Enable” column, the following additional systems represent more of the nine systems selected within Systems block 32 as illustrated in FIG. 9: Accumulation Distribution Crossover (FIG. 10), Trading Band Crossover (FIG. 10), Directional Movement (FIG. 11), And MACD With Moving Average (FIG. 12). Similarly, by fully displacing slider bar 48 from the top to the bottom, a user can readily determine the identity of all nine selected data processing algorithms.

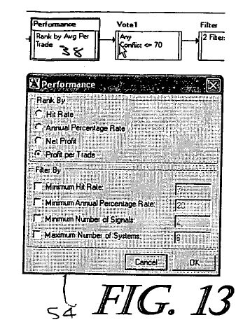

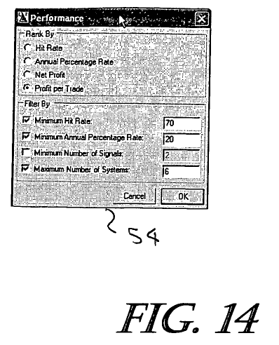

FIGS. 13 and 14 illustrate a Performance block which has been double-clicked from the minimized processing configuration 38 into the maximized reprogramming configuration designated by reference number 54. The maximized Performance block illustrates how the output from a Systems block 32 can be ranked by various criteria such as Annual Percentage Rate, Profit per Trade, etc., and may also be filtered by other criteria such as Minimum Annual Percentage Rate.

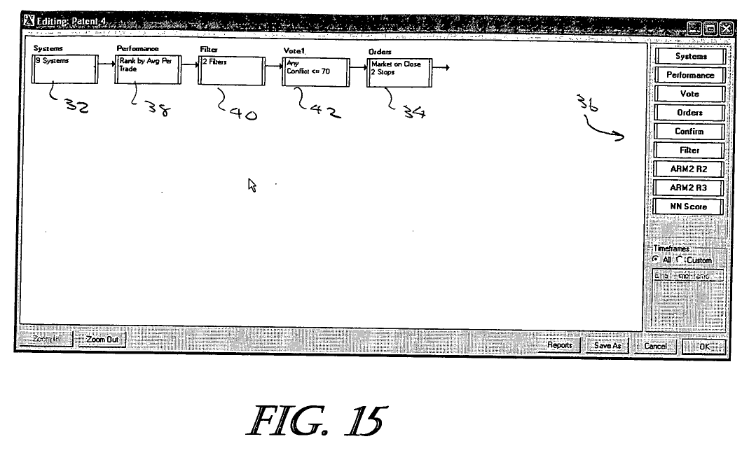

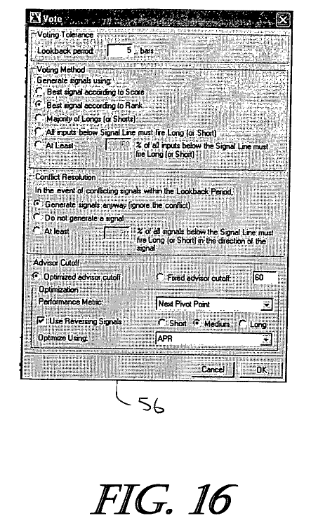

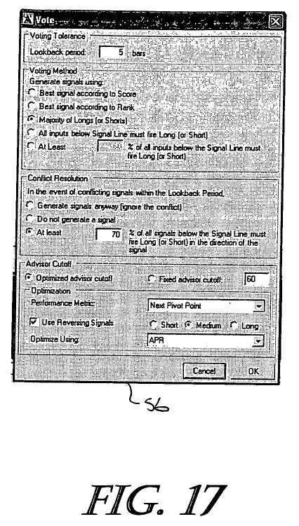

Referring now to FIGS. 15, 16 and 17, the minimized and maximized configurations of Vote block 42 will now be explained. FIG. 15 shows Vote block 42 in the minimized data processing configuration while FIGS. 16 and 17 shows that the Vote block has been double-clicked into the maximized reprogramming configuration 56 and that the Vote block internal processing parameters are now displayed and rendered reprogrammable. In FIG. 16, the Vote block has been configured to vote based on “Best signal according to Rank” while in FIG. 17, the Vote block 56 has select been programmed to the voting method designated “Majority of Longs (or Shorts).”

Both maximized Vote block elements 56 provide a conflict resolution methodology as well as for cutoff or elimination of Systems block data processing 18 outputs which have been quantified with what is referred to as an “Advisor Rating” where the advisor cutoff can either be computer optimized or based on a user-stated fixed advisor cutoff rating. When the computer optimization advisor cutoff is selected, maximized Vote block 56 provides for specific software optimization methods which are well known to persons of ordinary skill in the trading software field.

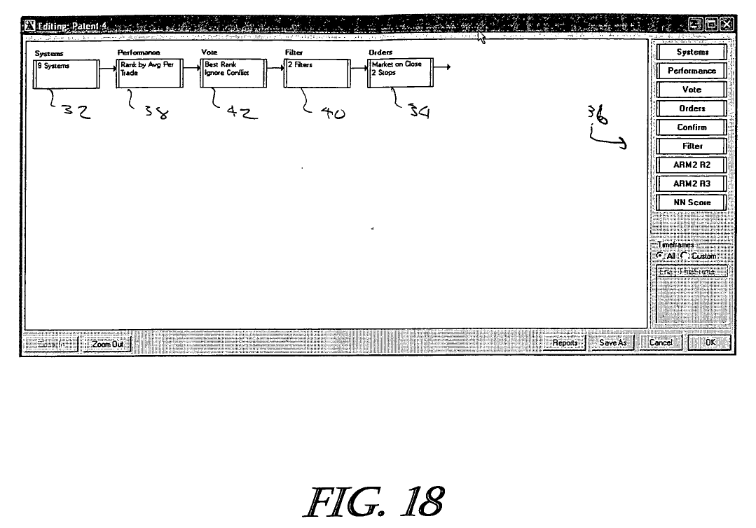

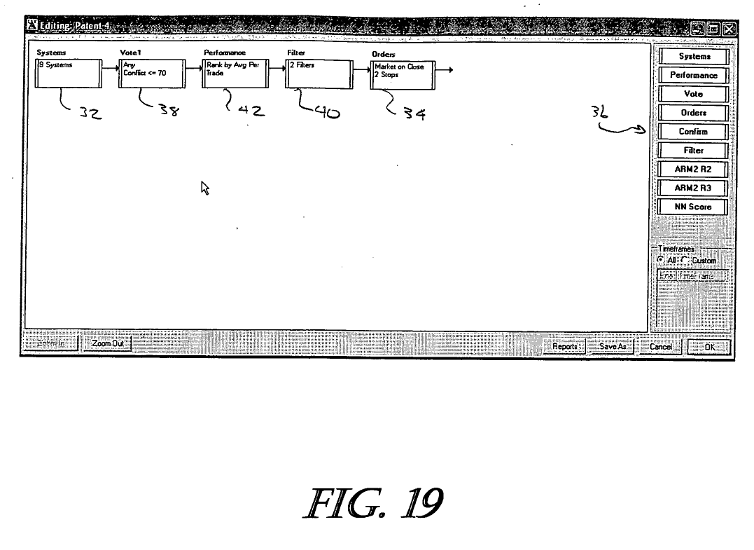

FIGS. 15, 18 and 19 illustrate various alternative sequential data processing block positions for Vote block 38, all of which were accepted as “allowed” and representing operative flow chart positions by the computer software.

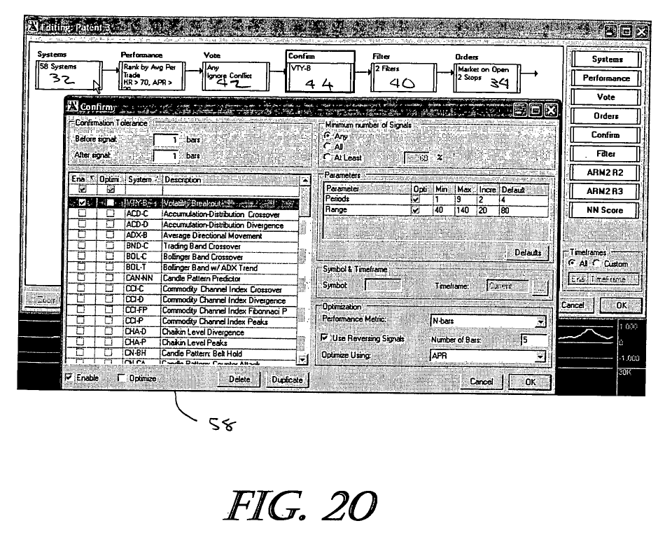

FIG. 20 illustrates that the Confirm or Confirmation Data Processing block 44 has been double-clicked by the user from the minimized data processing configuration 44 into the maximized reprogramming configuration 58. The checkmark in the Enable column of block 58 illustrates that the volatility breakout processing algorithm has been selected for the purpose of independently implementing that separately selected data processing algorithm on the price versus time data to “confirm” the validity of the output signals from the multiple data Systems block 32. As illustrated in the upper left portion of block 58 in FIG. 20, the Confirmation Tolerance both before and after the signal may be specified, the Minimum number of Signals required for confirmation be specified and the algorithm processing parameters may be selected to either be automatically optimized or may be manually specified by the user. Optimization when selected is implemented by various selectable performance metrics which are, once again, well known to those of ordinary skill in the field of trading software programming.

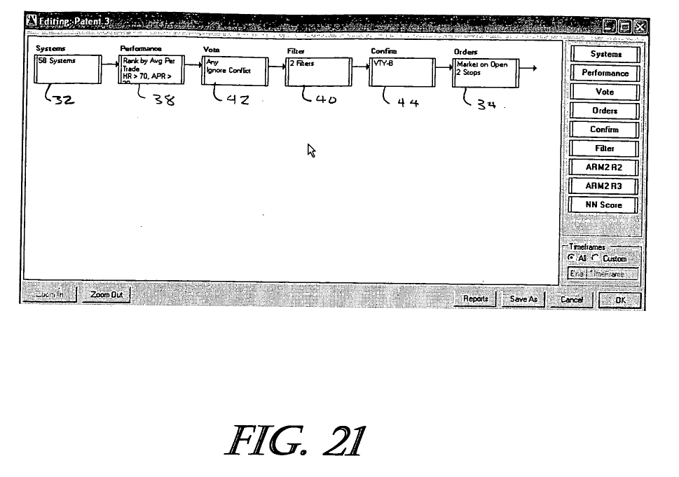

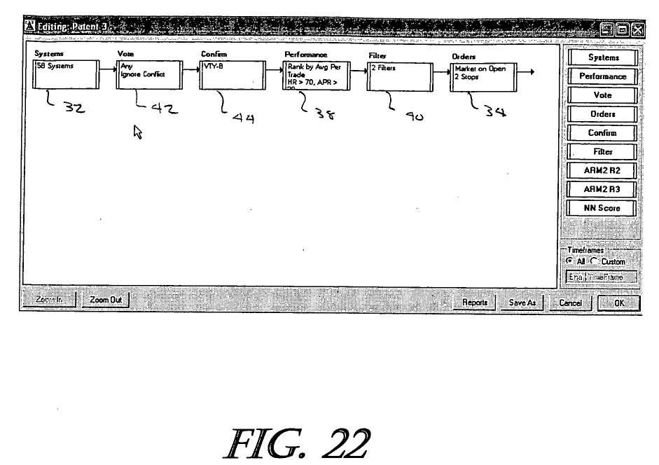

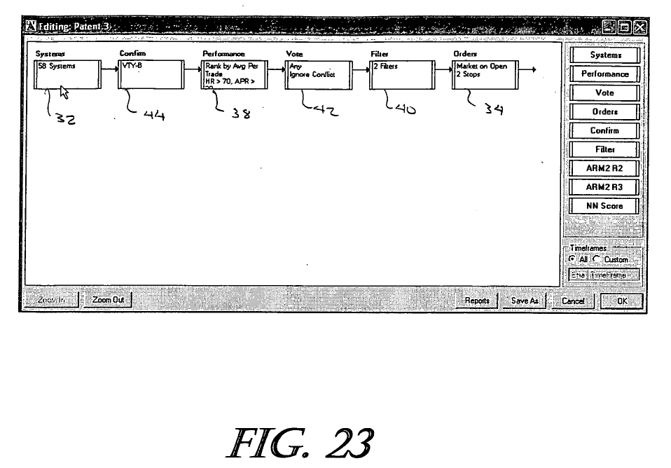

FIG. 21 illustrates the placement of Confirmation block 44 between Filter block 40 and Orders block 34. FIG. 22 illustrates that Confirmation block 44 has been positioned after Vote block 42 and before Performance block 38. FIG. 23 illustrates that Confirmation block 44 has been placed after Systems block 32 and before Performance block 38. Numerous other flow chart configurations and relative placements of the various data processing blocks within a user selected processing path can be readily implemented in a matter of seconds.

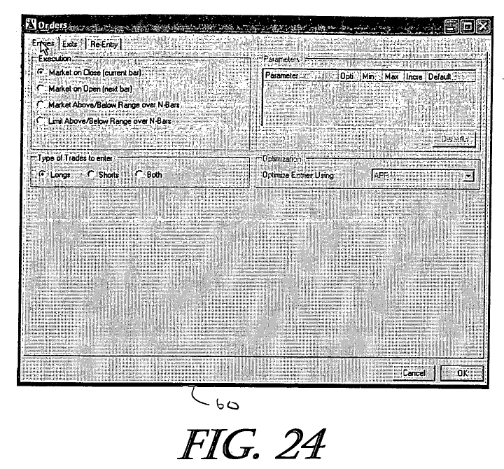

FIG. 24 illustrates Orders block 34 which has been double-clicked by the user into the maximized reprogramming configuration 60. As illustrated in FIG. 24, Orders block 34 includes three independently selectable tabs designated “Entries,” “Exits,” And “Re-Entry.”

In the Entries tab of the maximized Orders block 60 illustrated in FIG. 24, a user may choose various forms of entry execution based on an entry signal such as entry signal 10 as illustrated in FIG. 1. In FIG. 24, an entry based on “Market on close (current bar),” has been selected although three other options are provided and will control the placement of the actual vertical entry bar 70 as indicated on the FIG. 1 vote line 62. Entry bar 70 corresponds to the actual software recommended initiation of a particular trade entry. In FIG. 1, a space exists between vertical entry bar 70 and the triangular entry signal symbol 10 because, for that particular depiction, the Entries tab of block 60 selected a “market on open (next bar)” entry.

As further illustrated in FIG. 24, the Entries tab of Orders block 60 under the heading “Type of Trades to enter” has been checked as “Longs,” designating that as illustrated in FIG. 1, only long trades for standard purchases of positions will be processed and reflected on the vote line 62 of FIG. 1. As further illustrated in FIG. 24, the Entries tab can be configured to generate only short signals on vote line 62 or both long and short signals on vote line 62. The designation “shorts” refers to short selling in which the profit realized is based on falling prices rather than rising prices.

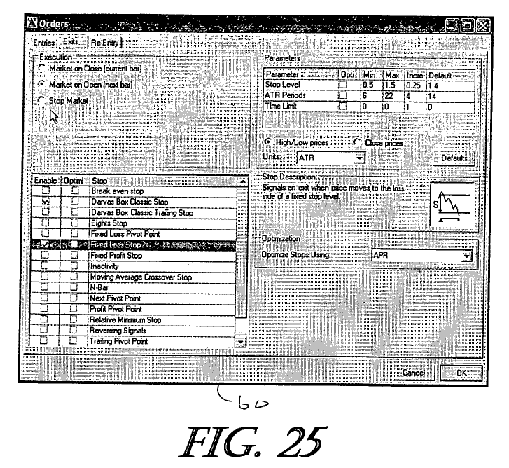

FIG. 25 illustrates the maximized Orders block “Exists” tab which provides numerous user-selectable exit criteria. Specifically in FIG. 25, Orders block 60 has selected only two exits based upon what is referred to as a “Darvis box classic stop” or a “fixed loss stop.” When the “fixed loss stop” is highlighted, the parameters illustrated in the parameters box relate to selection of a stop level. As previously, such parameters can either be automatically optimized or may be manually set by the user. In that same Parameters block, the user may specify that exit signals should be based on the “High-Low prices” made during a single trading day or trading period or that exit signals should be based on the “Close price” at the end of the trading day or trading period.

In the upper left-hand corner of Orders block 60 as illustrated in FIG. 25, execution of the exits is designated as occurring “Market On Open (next bar).” That same Market On Open stop has been illustrated in FIG. 1 as reflected by the delay between the generation of an exit signal 14 and the subsequent symbol 64 which reflects execution of the exit at the open of the market on the next day.

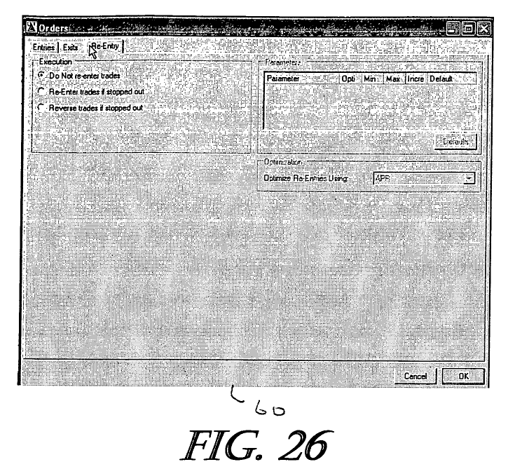

FIG. 26 illustrates the Re-Entry tab of the maximized Orders block 60 and that execution of the Re-Entry has been specified as “Do Not re-enter trades.”

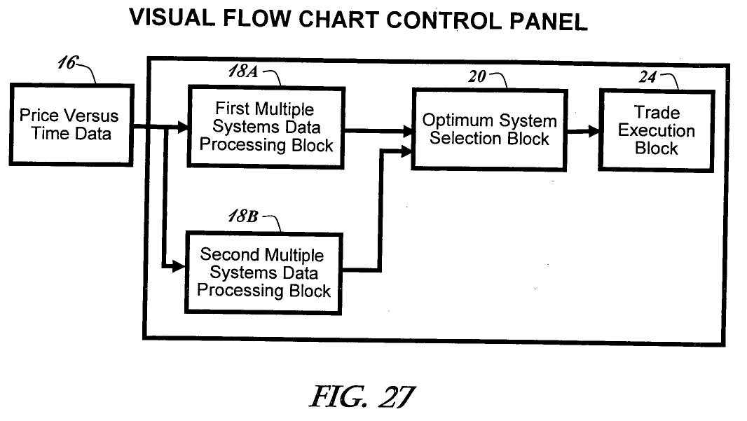

FIG. 27 illustrates a further modified visual flow chart in which the output of price versus time data 16 is coupled to Multiple Systems Data Processing block 18a as well as Multiple System Data Processing block 18b. The output of blocks 18a and 18b may be coupled to multiple inputs of System Selection block 20.

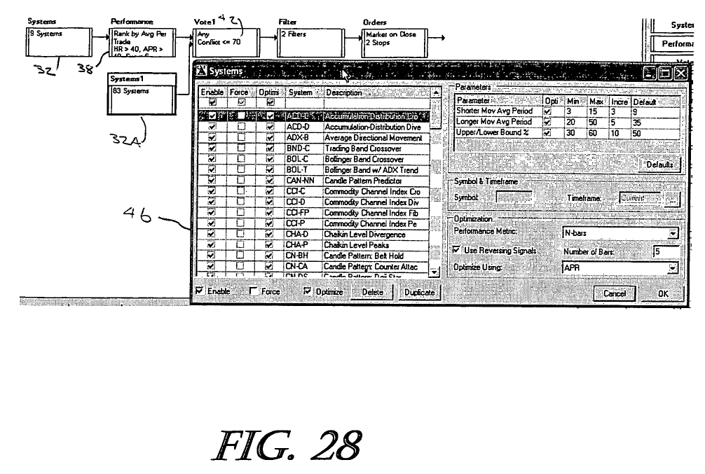

FIG. 28 represents a specific implementation of the dual mode or dual channel Multiple Systems Data Processing block configuration illustrated in FIG. 27 as specifically implemented with the preferred embodiment of the data processing flow chart control system of the present invention. In FIG. 28, a first Systems block 32 has been programmed to implement only nine different processing algorithms while the second Systems block designated as block 32A has been programmed to implement all eighty-three available data processing algorithms. The maximized Systems block 46 consistently illustrates that the Enable block has been checked for all depicted internally available data processing algorithms.

In FIG. 28, the output of lower Systems block 32A has been directly coupled to the input of Vote block 42 and that the output of upper Systems block 32 has been connected to flow first to Performance block 38 and then to Vote block 42.

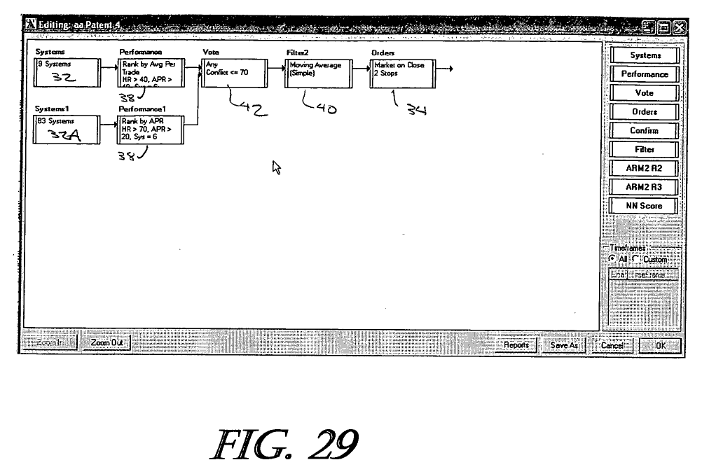

The dual channel processing configuration illustrated in FIG. 29 shows that the multiple outputs of both Systems blocks 32 and 32A have been coupled to separately programmable Performance blocks 38 and then into the multiple inputs of Vote block 42.

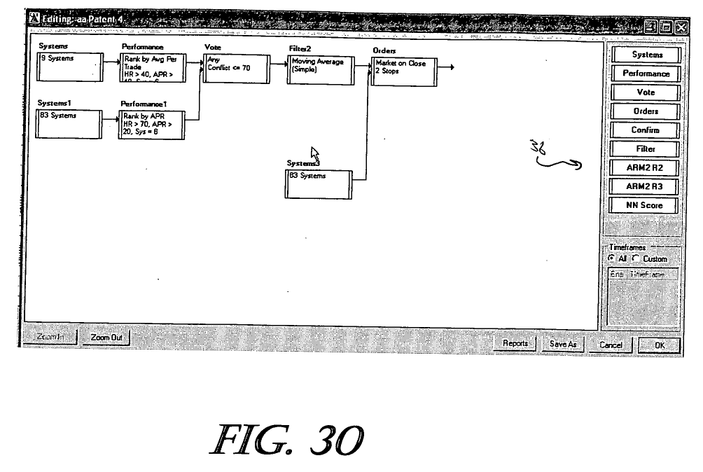

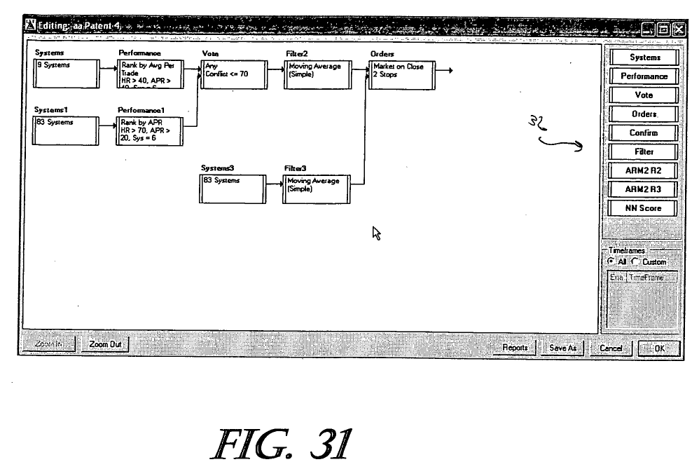

FIGS. 30 and 31 show alternative multiple data processing paths which may readily be visually programmed by selecting and positioning specified discrete function data processing blocks from flow chart selection panel 36 into multiple visually selected data processing paths.

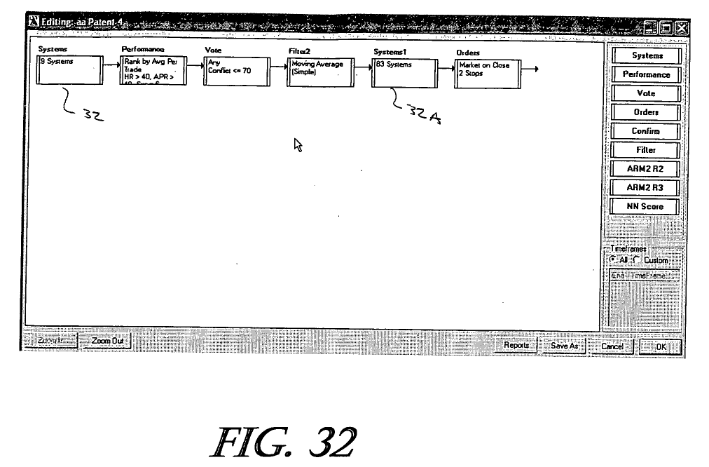

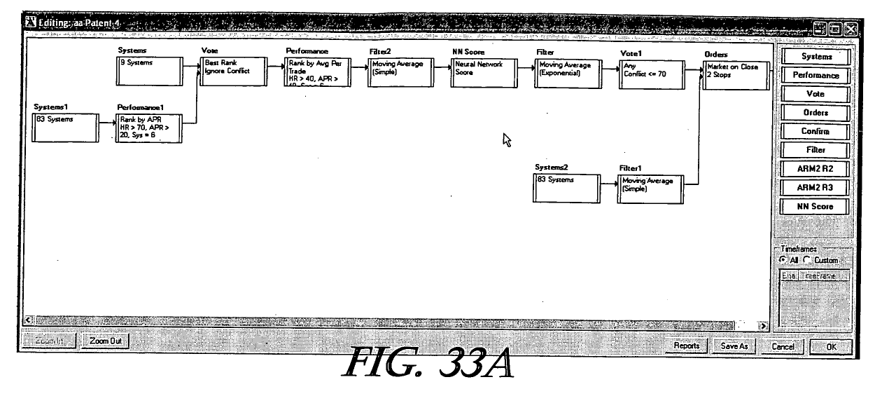

FIG. 32 further illustrates that secondary Systems block 32A may also be positioned in series with the data processing sequence rather than in parallel as previously illustrated.

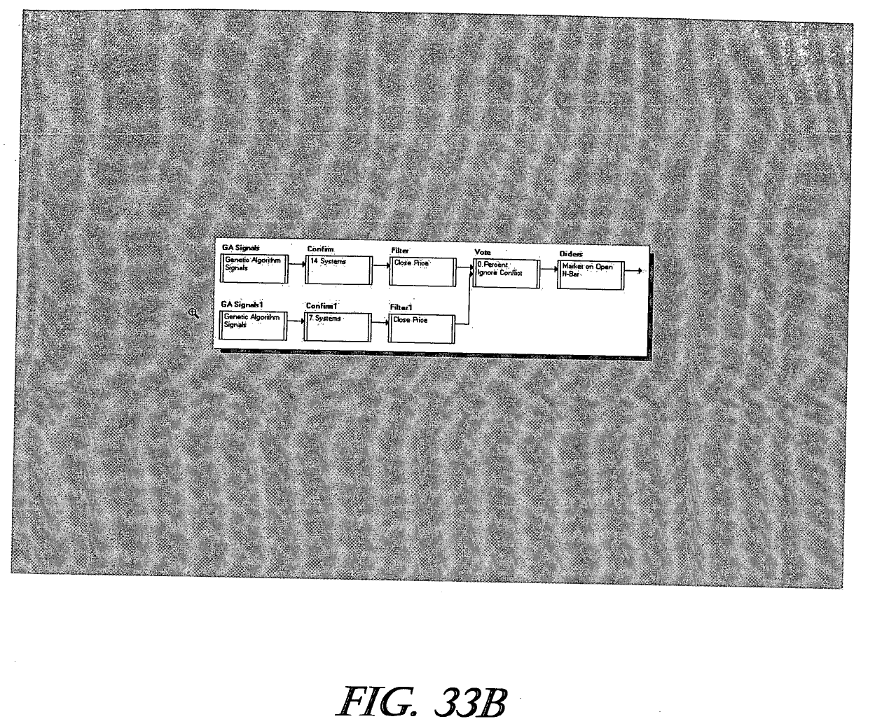

FIGS. 33A and 33B illustrate the use of two System blocks for independently but simultaneously processing input data with the results being separately sent to the inputs of a Vote block.

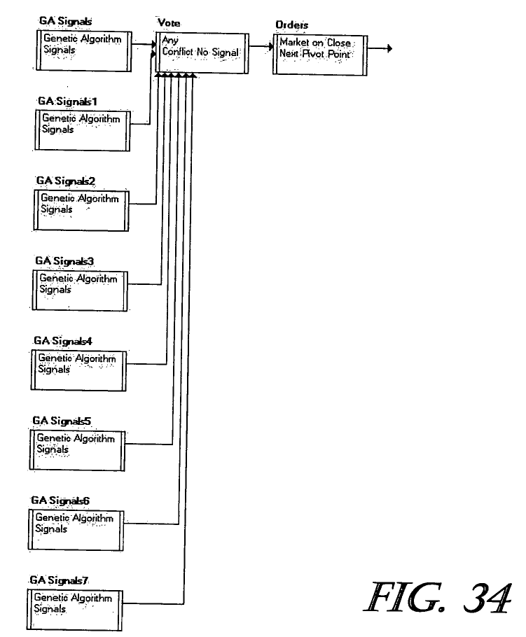

FIG. 34 illustrates the use of eight Systems blocks configured for implementing complex parallel data processing with the outputs being coupled to the inputs of a Vote block.

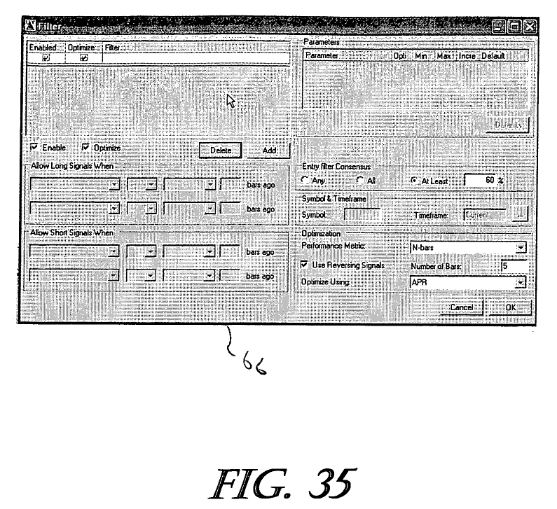

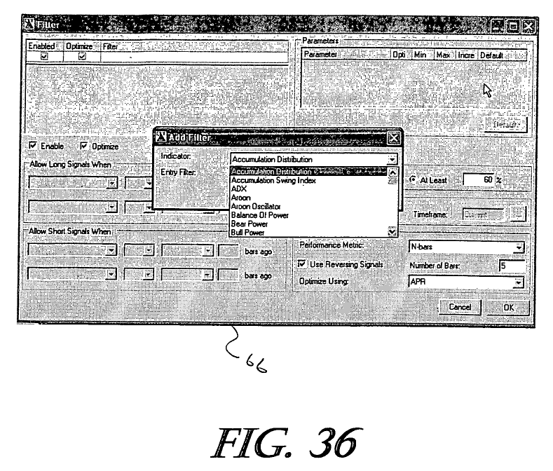

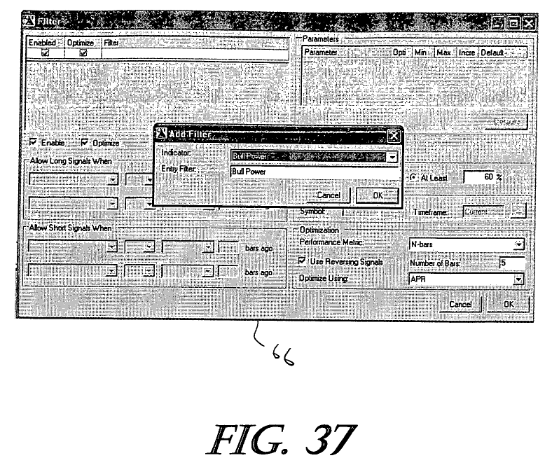

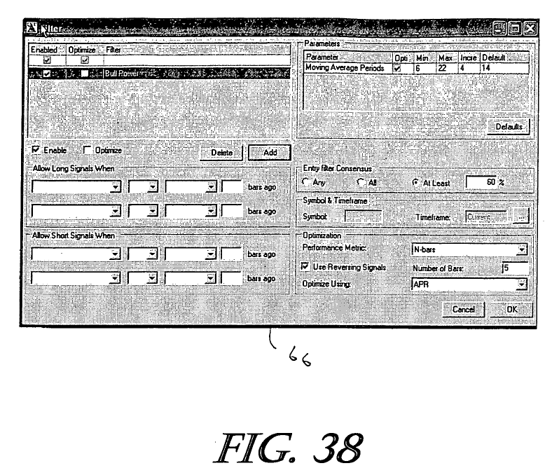

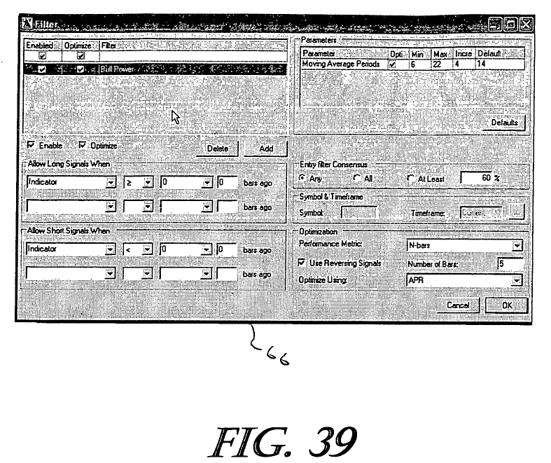

FIGS. 35-39 visually explain how filter criteria are selected and programmed after Filter block 40 has been double-clicked to toggle from the minimized data processing configuration into the maximized reprogramming configuration 66. In FIG. 35, the Filter block has been double-clicked into the maximized reprogramming configuration. As illustrated in FIG. 35, the user next clicks the “Add” button in the upper left hand corner of box 66 which brings up the “Add Filter” selection box as illustrated in FIG. 36. The “Bull Power” filter criteria appears at the lower depicted portion of the Add Filter box and may be selected as shown in FIG. 37. FIG. 38 illustrates that upon clicking the Add Filter OK box, the Bull Power filter criteria is selected and highlighted. FIG. 39 illustrates that the four “Allow Long signals when” drop down boxes allow an initial filter criteria to be designated where signals would be passed when the indicator “Bull Power” has a value equal to or greater than zero with a moving average period of fourteen with the Optimization block checked.

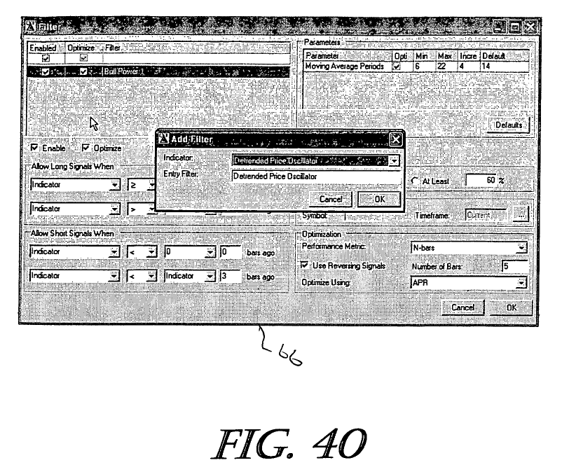

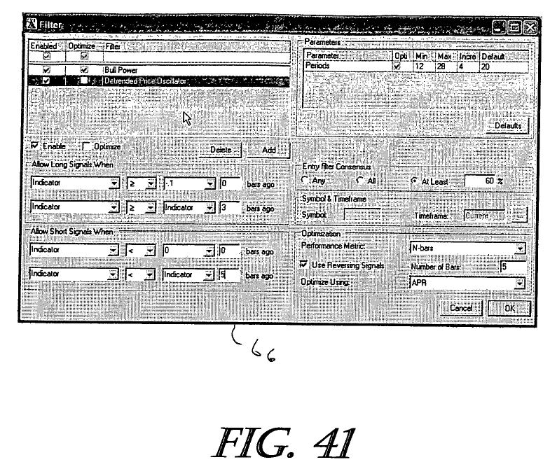

FIG. 40 illustrates that the Add Filter box may be activated to select another filter criteria such as the Detrended Price Oscillator. FIG. 41 illustrates that the Detrended Price Oscillator has now been selected and that multiple filter criteria has been designated under the headings “Allow Long signals when” and “Allow Short signals when.”

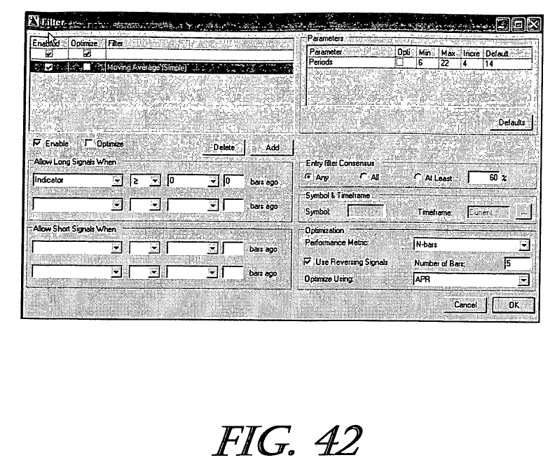

FIG. 42 illustrates that the filter criteria in the form of a simple moving average has been selected for the moving average period designated as 14.

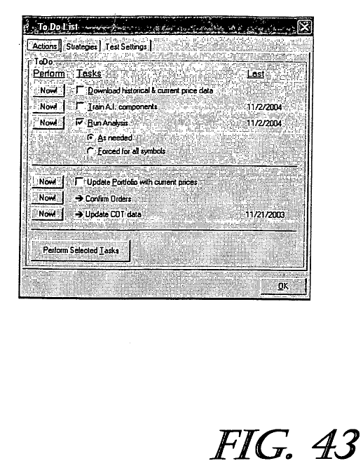

FIGS. 43-45 illustrate a more generalized system control panel designated as the “To Do List.” Under the “Actions” tab illustrated in FIG. 43, clicking the Perform Selected Tasks button triggers the computer to run the analysis based on previously stored stock data. Completion of the analysis will generate the signals indicated in FIG. 1, both on the vote line 62 as well as the voted signals line 68 which will be explained below.

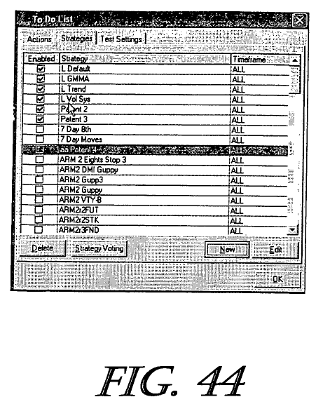

FIG. 44 illustrates that the Strategies tab has been selected under the To Do List. The checkmark in the left hand vertical column headed “Enabled” illustrates the specific strategies which have been selected.

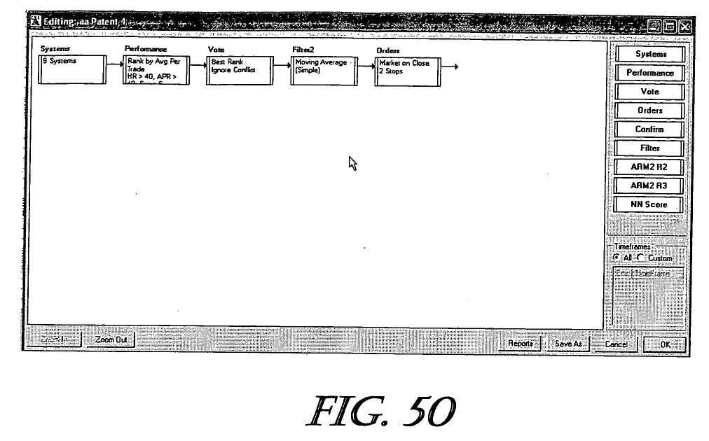

FIGS. 44 and 50 illustrate a representative strategy which was created by the data processing flow chart control system of the present invention to utilize nine systems followed by various sequentially implemented data processing blocks. As illustrated in the upper left hand corner of the outer block shown in FIG. 50, this particular strategy was entitled “aa Patent 4.” As illustrated in FIG. 44, that same aa Patent 4 strategy has been highlighted, but not enabled. That strategy has therefore been saved, but is not currently operating and will not generate any signals on voted signal line 68 as illustrated in FIG. 1. To activate the aa Patent 4 strategy, a user places a checkmark in the Enabled column of the Strategies tab of the To Do List illustrated in FIG. 44 and returns to the Actions tab under the To Do List as illustrated in FIG. 43 and clicks the Perform Selected Task button. Upon completion of that data processing procedure, a line designated “aa Patent 4” will appear on the voted signal line 68 in FIG. 1. The actual selected strategy signal output line which appears on vote line 62 will be determined by various factors including the Strategy Voting button illustrated at the bottom of the To Do List in FIG. 44. The operation of the Strategy Voting processing will be discussed below.

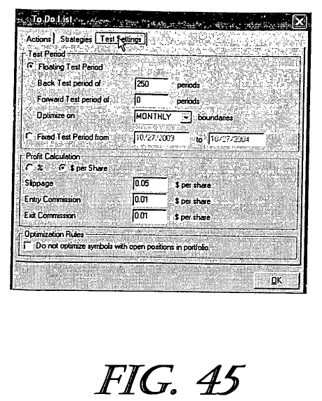

FIG. 45 illustrates the Test Settings tab of the To Do List in which a user can designate the back test period (two hundred and fifty periods in the FIG. 4 test settings) and various other criteria.

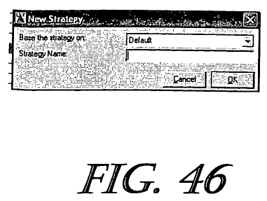

When the “New” button illustrated in FIG. 44 under the To Do List Strategies tab is clicked, the New Strategy box appears as illustrated in FIG. 46. When the strategy name has been inserted and the “OK” button is clicked on the New Strategy block, the FIG. 47 visual flow chart control panel appears and a user within a matter of seconds or minutes may visually construct a new strategy by selecting from flow chart selection panel 36 specific discrete function data processing blocks. The user next toggles each selected data processing block into the maximized reprogramming configuration as described above to customize the operation of each selected data processing block.

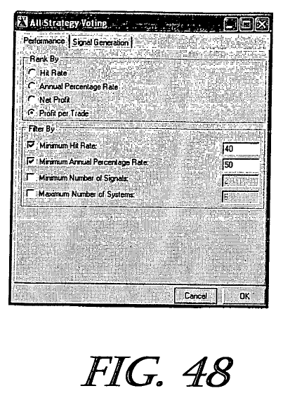

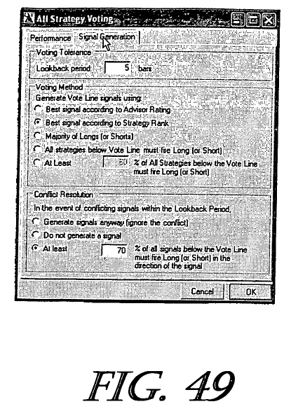

When the Strategy Voting button illustrated in FIG. 44 is clicked, the All Strategy Voting block illustrated in FIG. 48 is displayed. Under the depicted Performance tab, a user is permitted to designate the way in which the software ranks and selects one of the various voted signal line 68 signals for display on vote line 62 as illustrated in FIG. 1. The Signal Generation tab illustrated in FIG. 49 under the All Strategy Voting box similarly controls the voting process on the strategy signals illustrated on the voted signal line 68.

FIG. 50 illustrates one embodiment of the aa Patent 4 strategy which could readily created and specifically parameter-configured by a user within no more than about five minutes. By then selecting the To Do block, Actions tab as illustrated in FIG. 43 and the Perform Selected Tasks button, the computer will implement processing of all strategies selected on the FIG. 44 strategies selection list and will ultimately generate the FIG. 1 voted signal line 68 and vote line 62 based on the criteria explained above.

In the prior art OMNITRADER 2003 program, the software provided the user only the following fixed sequence location data processing blocks for processing data only in that single fixed sequence in-series path: first step—systems block; second step—performance block; third step—vote block; fourth step—confirm block; fifth step—filter block; and sixth step—orders block. OMNITRADER 2003 lacked any flow chart diagram data processing block depiction as has been illustrated with the data processing flow chart control system of the present invention and lacked the ability to vary the data processing sequence. Instead OMNITRADER 2003 was capable of only accessing and changing the internal data processing parameters of any data processing block on a one at a time basis. In other words, the OMNITRADER 2003 vote block (which represented an internal, undisplayable software function) internal processing parameter adjustment screen could be displayed on the computer monitor screen only by itself. The user was not able to create a viewable screen showing where in a processing sequence a particular data processing block was located, nor could the user alter the fixed block to block processing sequence.

As explained above and illustrated in the extensive series of patent drawing figures, the data processing sequence control system of the present invention may be controlled or “programmed” to include a virtually unlimited number of discrete data processing blocks where the number of blocks can be reduced to a Systems block and an Orders block or can be expanded to tens, hundreds or thousands of blocks configured for either serial processing, parallel processing or a combination of serial and parallel processing, followed by serial processing, followed by parallel processing, etc.

Not only may the number of data processing blocks be modified, but the relative sequencing of all selected data processing steps can easily be user modified in any way the user desires, as long as the selected sequence is not configured into a previously programmed “disallowed” state or sequence.

While the system and method of the present invention has been described in the context of data processing blocks having various names, the scope of the present invention encompasses numerous additional data processing algorithms, as well as matching, comparison or correlation steps or algorithms or additional confirmation concepts, filtering concepts, neural network scoring concepts or any other of a long list of alternative data processing, data analysis or data reduction techniques well known by those ordinary of skill in the data processing programming field.

While the preferred embodiment of the invention currently utilizes visible flow chart data processing blocks, the inventive concept could also readily be implemented in the form of non-flow chart/non-diagrammatic text format lists, numerical listings or sequences, symbols or logical statements. In addition, the relative data processing sequence or order could be specified by the relative position of an algorithm name or data processing function in a text list or in a number list separated by, for example, commas or separated into subparagraph format or into an outline configuration or any other alternative relative position specifying data processing sequencing convention. Such conceptually identical means for defining the types of data processing blocks intended to be implemented, the series/parallel configuration of the processing steps as well as the desired sequencing or sequencing alternatives would be readily apparent to persons of ordinary skill in the programming field based on the teachings of the present document.

Yet another method for controlling the configuration of each data processing block, the definition of the processing sequence and the definition of the exact form of series/parallel data processing path could readily be defined by highlighting a selected box in a predefined matrix or grid depicting predefined data processing blocks. The desired processing sequence could be assigned by drawing a sequencing-indicating line or arrows interconnecting various elements within the data processing matrix or grid to define the processing order or sequence or by assigning a numerical value to each selected element or member of the data processing matrix or grid to indicate the selected processing sequence or the serial or parallel data processing configuration.

The enormous flexibility of the data processing control system of the present invention allows for the stepwise refinement with resulting performance enhancement of a trading analysis concept or theory by allowing a user to initially implement a data analysis concept with a few data processing blocks, to then check the performance results over a back test period and to subsequently add additional data processing blocks, to modify the internal parameters of selected data processing blocks or to modify the data processing block sequence or to add additional series or parallel data processing sequences to all or part of the selected data processing chain. Each trading strategy design modification could be followed by a back testing performance evaluation step to determine whether the modified trading strategy data processing concepts have produced either improved or degraded results. Based on the performance of the modified strategy compared to the prior strategy, the user “programmer” may easily and quickly continue modifying numerous elements of the new strategy being developed to create an optimized arrangement of data processing blocks with optimized processing parameters configured in an optimized series/parallel sequence, limited only by the requirement that the proposed trading strategy begins with a Systems block and ends with an Orders block.

Based on the extensive series of patent drawings discussed above in combination with the related written description, a person of ordinary skill in the trading software programming field would be readily enabled to write the software necessary to implement the data processing flow chart control system of the present invention. While the present document describes only the currently preferred embodiment of the invention, it would be readily apparent to such persons of ordinary skill in the art based on the extensive collection of patent drawing figures and the related written description how to modify the disclosed preferred embodiment in numerous ways without departing or deviating from the context of the present invention. Accordingly, it is intended by the appended claims to cover all such modifications of the invention which fall within the true spirit and scope of the invention.

I claim:

1. A data processing flow chart control system comprising:
a. a series of independent data processing blocks for receiving input data corresponding to price versus time data for a variable price item and for generating time-related entry and exit signals corresponding to the acquisition and disposition of rights to the variable price item; and
b. a visual flow chart control panel selectively configurable between a closed data processing configuration and an open programming configuration for selectively allowing each data processing block to be reconfigured between a minimized data processing configuration and a maximized block reprogramming configuration.

2. The data processing flow chart control system of claim 1 further including a flow chart block selection panel displayed when the visual flow chart control panel is configured in the maximized block reprogramming configuration for providing a source for a defined group of selectable discrete function data processing blocks

3. The data processing flow chart control system of claim 2 wherein the flow chart block selection panel includes a multiple systems data processing block incorporating two or more selectively activated data processing algorithms for independently processing the price versus time data over a preset back test period and for periodically generating a discrete trade execution output signal for each algorithm, the multiple systems data processing block having a minimized processing configuration and a maximized reprogramming configuration in which internal processing parameters are displayed and rendered reprogrammable.

4. The data processing flow chart control system of claim 3 wherein the flow chart block selection panel includes a system selection block for ranking the quality of the signals generated by each data processing algorithm over the back test period, for rejecting the lower quality signals and for passing only the highest quality trade execution signal to an output line, the system selection block having a minimized processing configuration and a maximized programming configuration in which internal processing parameters are displayed and rendered reprogrammable.

5. The data processing flow chart control system of claim 4 wherein the flow chart block selection panel includes a trade execution block for generating valid trade execution signals in response to the signal passed to the system selection block output line, the trade execution block having a minimized processing configuration and a maximized programming configuration in which internal processing parameters are displayed and rendered reprogrammable.

6. The data processing flow chart control system of claim 5 wherein the flow chart block selection panel includes a performance ranking block for receiving each of the processed outputs generated by the multiple systems data processing block and for ranking the relative performance of each data processing algorithm over the back test period.

7. The data processing flow chart control system of claim 6 wherein the flow chart block selection panel includes a voting block for selecting according to a predetermined criteria the single most optimum output signal from the performance ranking block.

8. The data processing flow chart control system of claim 7 wherein the flow chart block selection panel includes a filter block for filtering out signals not meeting predetermined filter criteria.

9. The data processing flow chart control system of claim 5 wherein the flow chart block selection panel includes a confirmation block for independently implementing a separate data processing algorithm on the price versus time data to confirm the validity of the output signals from the multiple systems data processing block.

10. The data processing flow chart control system of claim 1 wherein the visual flow chart control panel in the minimized configuration allows a user to selectively reposition the relative sequential position of the data processing blocks.

11. The data processing flow chart control system of claim 10 wherein the visual flow chart control panel includes allowed and disallowed relative sequential positions for the specific data processing blocks relative to other data processing blocks.

12. A data processing flow chart control system including a series of independent data processing blocks for receiving input data corresponding to price versus time data for a variable price item and for generating time-related entry and exit signals corresponding to the acquisition and disposition of rights to the variable price item, comprising:
a. a visual flow chart control panel selectively configurable between a closed data processing configuration and an open programming configuration for selectively reconfiguring each data processing block between a minimized data processing configuration and a maximized block reprogramming configuration;
b. a multiple systems data processing block positioned within the visual flow chart control panel incorporating two or more selectively activated data processing algorithms for independently processing the price versus time data over a preset back test period and for periodically generating a discrete trade execution output signal for each algorithm, the multiple systems data processing block having a minimized processing configuration and a maximized reprogramming configuration in which internal processing parameters are displayed and rendered reprogrammable;
c. a system selection block positioned within the visual flow chart control panel for ranking the quality of the signals generated by each data processing algorithm over the back test period, for rejecting the lower quality signals and for passing only the highest quality trade execution signal to an output line, the system selection block having a minimized processing configuration and a maximized programming configuration in which internal processing parameters are displayed and rendered reprogrammable; and
d. a trade execution block for generating valid trade execution signals in response to the signal passed to the system selection block output line, the trade execution block having a minimized processing configuration and a maximized programming configuration in which internal processing parameters are displayed and rendered reprogrammable.

13. The data processing flow chart control system of claim 12 wherein the visual flow chart control panel in the minimized configuration allows a user to selectively reposition the relative sequential position of the data processing blocks.

14. The data processing flow chart control system of claim 13 wherein the visual flow chart control panel includes allowed and disallowed relative sequential positions for specific data processing blocks relative to other data processing blocks.

15. The data processing flow chart control system of claim 14 wherein the system selection block further includes a performance ranking block for receiving each of the processed outputs generated by the multiple systems data processing block and for ranking the relative performance of each data processing algorithm over the back test period.

16. The data processing flow chart control system of claim 15 wherein the system selection block further includes a voting block for selecting according to a predefined criteria the single most optimum output signal from the performance ranking block.

17. The data processing flow chart control system of claim 13 wherein the system selection block further includes a filter block for filtering out signals not meeting predefined filter criteria.

18. The data processing flow chart control system of claim 13 wherein the system selection block further includes a confirmation block for independently implementing a separate data processing algorithm on the price versus time data to confirm the validity of the output signals from the multiple systems data processing block.

19. The data processing flow chart control system of claim 12 further including a flow chart selection panel displayed when the visual flow chart control panel is configured in the maximized block reprogramming configuration for providing a source for a defined group of selectable discrete function data processing blocks.

20. A data processing method comprising the steps of:
a. receiving input data corresponding to price versus time data for a variable price item, processing the data through a series of independent data processing blocks and generating time-related entry and exit signals corresponding to the acquisition and disposition of rights to the variable price item;
b. providing a data processing sequence control system selectively configurable between a closed data processing configuration and an open programming configuration;
c. in the open programming configuration selectively reconfiguring each data processing block between a data processing configuration and a block reprogramming configuration; and
d. in the reprogramming configuration reprogramming the internal data processing parameters of each data processing block.

21. The method of claim 20 including the further step of configuring the data processing sequence control system into the open programming configuration, creating a first trading strategy by selecting two or more distinct data processing blocks, programming the internal data processing parameters of each selected data processing block, arranging the selected data blocks into a user-defined processing sequence, and reconfiguring the data processing sequence control system into the closed data processing configuration.

22. The method of claim 21 including the further step of processing the input data over a user-defined back test period to generate a series of time-related entry and exit signals and evaluating the performance of the first trading strategy over that back test period.

23. The method of claim 22 including the further step of configuring the data processing sequence control system into the open programming configuration, creating a second trading strategy based on but different from the first trading strategy by implementing one or more of the following steps: 1) changing the number or selection of the data processing blocks used in the first trading strategy; 2) rearranging the sequence of the selected data processing blocks, and 3) reprogramming the internal data processing parameters of each selected data processing block followed by the step of reconfiguring the data processing sequence control system into the closed data processing configuration.

24. The method of claim 23 including the further step of processing the input data over the user-defined back test period to generate a series of time-related entry and exit signals and evaluating the performance of the second trading strategy over the back test period.

25. The method of claim 24 including the further step of comparing the performance of the first trading strategy with the performance of the second trading strategy.

26. The method of claim 25 including the further step of creating a third trading strategy based on but different from the first and second trading strategies by implementing one or more of the following steps: 1) changing the number or selection of the data processing blocks used in the second trading strategy; 2) rearranging the sequence of the selected data processing blocks, and 3) reprogramming the internal data processing parameters of each selected data processing block following by the step of reconfiguring the data processing sequence control system into the closed data processing configuration.

27. The method of claim 26 including the further step of processing the input data over the user-defined back test period to generate a series of time-related entry and exit signals and evaluating the performance of the third trading strategy over the back test period.

28. The method of claim 27 including the further step of comparing the performance results achieved over the back test period by the first trading strategy, the second trading strategy and the third trading strategy and continuing the trading strategy modification process based on those comparative results.

29. The method of claim 20 wherein the data processing sequence control system includes a visual flow chart control panel.

30. The method of claim 20 wherein the data processing block processing configuration represents a minimized block configuration and wherein the data processing block reprogramming configuration represents a maximized block configuration.

31. The method of claim 30 including the further steps of providing a flow chart block selection panel depicting a plurality of available data processing blocks each having a different data processing function, displaying the flow chart block selection panel when the visual flow chart control panel is configured into the maximized block reprogramming configuration, and creating a new flow chart arrangement of data processing blocks by visually sequentially selecting a plurality of the data processing blocks from the flow chart block selection panel and visually arranging the selected data processing blocks into a desired flow chart sequence.

32. The method of claim 31 including the further step of reconfiguring the visual flow chart control panel into the closed data processing configuration and digitally processing the input data in a manner consistent with the visually selected and visually arranged data processing blocks to generate the time-related entry and exit signals.

33. The method of claim 31 wherein the input data is initially processed within a multiple system data processing block incorporating two or more selectively activated data processing algorithms to independently process the price versus time data over a preset back test period.

34. The method of claim 33 wherein the multiple system data processing block periodically generates a discrete trade execution output signal for each data processing algorithm.

35. The method of claim 31 including the further step of selecting from the flow chart block selection panel an orders data processing block specially configured to generate the time-related exit signals and visually arranging the orders data processing block into the final sequential data processing location in the flow chart sequence.
